(19) United States
(12) Patent Application Publication
(10) Pub. No.: US 2005/0088935 A1
(43) Pub. Date: Apr. 28, 2005

(54) Clock signal generation apparatus, apparatus for generating a clock signal using an information recording medium, integrated circuit, clock signal generation method, and method for generating a clock signal using an information recording medium

(76) Inventors: Kohei Nakata, Osaka (JP); Makoto Usui, Osaka (JP); Toyoji Gushima, Osaka (JP); Takeshi Nakajima, Nara (JP)

Correspondence Address: MARK D. SARALINO (GENERAL);RENNER, OTTO, BOISELLE & SKLAR, LLP, 1621 EUCLID AVENUE, NINETEENTH FLOOR, CLEVELAND, OH, 44115-2191, US

(21) Appl. No.: 10/971,950

(22) Filed: Oct. 22, 2004

(30) Foreign Application Priority Data
Oct. 24, 2003 (JP) 2003-364248

(51) Int. Cl. G11B 5/09

(52) U.S. Cl. 369/47.27; 369/47.28; 369/59.21

(57) ABSTRACT

A clock signal generation apparatus is provided for generating a clock signal synchronized with a wobble signal, which comprises an oscillation section for generating the clock signal, a counter section for generating a predetermined count value, a phase comparison section for integrating an amplitude value of the wobble signal over a predetermined interval specified based on the predetermined count value to obtain a first integrated value, and obtaining a phase difference value indicating a phase difference between the wobble signal and the clock signal based on the first integrated value, and a control signal generation section for generating a control signal based on the phase difference value, the control signal being used for controlling a frequency of the clock signal. The oscillation section adjusts the frequency of the clock signal based on the control signal.

This non-provisional application claims priority under 35 U.S.C. §119(a) on Patent Application No. 2003-364248 filed in Japan on Oct. 24, 2003, the entire contents of which are hereby incorporated by reference.

### BACKGROUND OF THE INVENTION

1. Field of the Invention

The present invention relates to an apparatus, an integrated circuit, and a method for generating a clock signal.

2. Description of the Related Art

Conventionally, recordable optical disc media are provided with track grooves previously formed. Information is recorded along the track grooves. Specifically, information is recorded in the track groove or a region (land) interposed between the track grooves. The track groove meanders in a sine wave pattern. Information is recorded in synchronization with a clock signal which is generated based on cycles of the wobble. The clock signal is in synchronization with the wobble cycle. Such a clock signal is generally produced using a phase locked loop (PLL) (see, for example, Japanese Laid-Open Publication Nos. 2000-113597 and 2002-203380).

FIG. 13 is a block diagram showing a conventional recording apparatus 2000 comprising a PLL for generating a clock signal. The recording apparatus 2000 comprises an optical head section 102, a wobble detection circuit 801, a phase comparator 802, a charge pump 803, a loop filter 804, a voltage control oscillator (VCO) 805, and a frequency divider 806.

An information recording medium 101 is a recordable medium having a wobbling track, such as an optical disc. The optical head section 102 irradiates the information recording medium 101 with laser light, detects light reflected from the information recording medium 101, and outputs a reproduction signal based on the result of detection. The wobble detection circuit 801 detects the wobble signal from the reproduction signal output by the optical head section 102, and outputs a two-valued wobble signal. The phase comparator 802 compares the phase of a frequency-divided clock signal with the phase of a wobble signal. The charge pump 803 controls current. The loop filter 804 smoothes an output of the charge pump 803. The voltage control oscillator (VCO) 805 generates a clock signal having a frequency based on an output voltage of the loop filter 804. The frequency divider 806 divides a clock signal to generate a frequency-divided clock signal.

The phase comparator 802 compares the rising edge position and the falling edge position of a wobble signal with those of a frequency-divided clock signal. When the edge of a frequency-divided clock signal lags delayed, the phase comparator 802 outputs an UP signal having a width based on the delay time. When the edge of the frequency-divided clock signal lags, the phase comparator 802 outputs a DOWN signal having a width based on the advanced time. The charge pump 803 releases or takes in electric charge, depending on the UP signal or the DOWN signal which is received. With this operation, the amount of charge taken in by the subsequent loop filter 804 is controlled to change the output voltage of the loop filter 804. By controlling the output voltage of the loop filter 804, the oscillation frequency of the subsequent VCO 805 is controlled. A clock signal generated by the VCO 805 is divided by the frequency divider 806. These components are operated so that a phase difference between a frequency-divided clock signal and a wobble signal approaches 0°.

However, in the above-described conventional technique, a wobble signal and a clock signal are synchronized with each other only based on the edge positions of the wobble signal and the clock signal. Therefore, as shown in FIG. 14, leakage (crosstalk) of reflected light from an adjacent track causes a change in the amplitude or duty ratio of a wobble signal, and noise causes jitter. In the worst case, these influences cause the oscillation frequency of a clock signal to be unstable during data recording, so that recorded data cannot be reproduced after recording.

If the gain of the loop filter 804 is reduced in order to improve the stability of generation of a clock signal, the operation of the PLL becomes slow. In this case, it takes a long time until data recording can be started, so that a high level of access performance cannot be assured.

There are various recordable optical disc formats, such as DVD-RAM, DVD-RW, DVD+RW, and the like. These formats have different track wobble cycles. Therefore, in the above-described conventional technique which measures a phase difference between a wobble signal and a clock signal based on time, it is necessary to change the gain of the phase comparator 802 for each format. Therefore, a recording apparatus capable of handling a plurality of formats needs to have a loop filter specialized for each -format, leading to a complex circuit structure.

### SUMMARY OF THE INVENTION

According to an aspect of the present invention, a clock signal generation apparatus is provided for generating a clock signal synchronized with a wobble signal, which comprises: an oscillation section for generating the clock signal; a counter section for generating a predetermined count value; a phase comparison section for integrating an amplitude value of the wobble signal over a predetermined interval specified based on the predetermined count value to obtain a first integrated value, and obtaining a phase difference value indicating a phase difference between the wobble signal and the clock signal based on the first integrated value; and a control signal generation section for generating a control signal based on the phase difference value, the control signal being used for controlling a frequency of the clock signal. The oscillation section adjusts the frequency of the clock signal based on the control signal.

In one embodiment of this invention, the phase comparison section may integrate an absolute value of the amplitude of the wobble signal over the predetermined interval to obtain a second integrated value. The phase comparison section may perform division between the first integrated value and the second integrated value to obtain the phase difference value.

In one embodiment of this invention, the wobble signal may be generated based on a wobbling shape possessed by at least one track contained in an information recording medium.

In one embodiment of this invention, the counter section may sample a polarity of the wobble signal every predetermined cycle, and when a reverse state of the polarity continues a predetermined number of sampling times or more, may shift a timing for generation of the predetermined count value by half a cycle of the wobble signal.

In one embodiment of this invention, the phase comparison section may integrate an absolute value of the amplitude of the wobble signal over the predetermined interval to obtain a second integrated value. The phase comparison section may output a signal indicating that the phase difference value is 0, when the second integrated value is smaller than a predetermined threshold.

In one embodiment of this invention, the phase comparison section may integrate an absolute value of the amplitude of the wobble signal over the predetermined interval to obtain a second integrated value. The phase comparison section may perform division between the first integrated value and the second integrated value, and when a result of the division changes by more than a predetermined value from a result of a previous division, may output a signal indicating that the phase difference value is 0.

In one embodiment of this invention, the wobble signal may be generated based on a wobbling shape of at least one track possessed by an information recording medium. A prepit may be previously provided at a position on the information recording medium, the position having a predetermined phase relationship with the wobble of the at least one track. The clock signal generation apparatus may further comprise a prepit signal detection section for detecting a prepit signal from a reproduction signal obtained by irradiating the information recording medium with laser light. The phase comparison section may integrate an absolute value of the amplitude of the wobble signal over the predetermined interval to obtain a second integrated value, and may integrate the amplitude of the wobble signal using the prepit signal as a reference to obtain a third integrated value. The phase comparison section may perform subtraction between the first integrated value and the third integrated value, and may perform division between a result of the subtraction and the second integrated value to obtain the phase difference value.

According to another aspect of the present invention, an apparatus for generating a clock signal using an information recording medium is provided. The information recording medium comprises at least one track having a wobbling shape. The apparatus comprises: a wobble signal generation section for generating a wobble signal based on the wobbling shape in accordance with a reproduction signal obtained by irradiating the information recording medium with laser light; and a clock signal generation section for generating the clock signal synchronized with the wobble signal. The clock signal generation section comprises: an oscillation section for generating the clock signal; a counter section for generating a predetermined count value; a phase comparison section for integrating an amplitude value of the wobble signal over a predetermined interval specified based on the predetermined count value to obtain a first integrated value, and obtaining a phase difference value indicating a phase difference between the wobble signal and the clock signal based on the first integrated value; and a control signal generation section for generating a control signal based on the phase difference value, the control signal being used for controlling a frequency of the clock signal. The oscillation section adjusts the frequency of the clock signal based on the control signal.

In one embodiment of this invention, the phase comparison section may integrate an absolute value of the amplitude of the wobble signal over the predetermined interval to obtain a second integrated value. The phase comparison section may perform division between the first integrated value and the second integrated value to obtain the phase difference value.

According to another aspect of the present invention, an integrated circuit for generating a clock signal synchronized with a wobble signal is provided, which comprises: an oscillation section for generating the clock signal; a counter section for generating a predetermined count value; a phase comparison section for integrating an amplitude value of the wobble signal over a predetermined interval specified based on the predetermined count value to obtain a first integrated value, and obtaining a phase difference value indicating a phase difference between the wobble signal and the clock signal based on the first integrated value; and a control signal generation section for generating a control signal based on the phase difference value, the control signal being used for controlling a frequency of the clock signal. The oscillation section adjusts the frequency of the clock signal based on the control signal.

In one embodiment of this invention, the phase comparison section may integrate an absolute value of the amplitude of the wobble signal over the predetermined interval to obtain a second integrated value. The phase comparison section may perform division between the first integrated value and the second integrated value to obtain the phase difference value.

According to another aspect of the present invention, a clock signal generation method for generating a clock signal synchronized with a wobble signal is provided, which comprises the steps of: (a) generating the clock signal; (b) generating a predetermined count value; (c) integrating an amplitude value of the wobble signal over a predetermined interval specified based on the predetermined count value to obtain a first integrated value, and obtaining a phase difference value indicating a phase difference between the wobble signal and the clock signal based on the first integrated value; and (d) generating a control signal based on the phase difference value, the control signal being used for controlling a frequency of the clock signal. Step (a) may comprise adjusting the frequency of the clock signal based on the control signal.

In one embodiment of this invention, step (c) may comprise: integrating an absolute value of the amplitude of the wobble signal over the predetermined interval to obtain a second integrated value; and performing division between the first integrated value and the second integrated value to obtain the phase difference value.

In one embodiment of this invention, the wobble signal may be generated based on a wobbling shape of at least one track possessed by an information recording medium.

In one embodiment of this invention, step (b) may comprise sampling a polarity of the wobble signal every predetermined cycle, and when a reverse state of the polarity continues a predetermined number of sampling times or more, shifting a timing for generation of the predetermined count value by half a cycle of the wobble signal.

In one embodiment of this invention, step (c) may comprise: integrating an absolute value of the amplitude of the wobble signal over the predetermined interval to obtain a second integrated value; and outputting a signal indicating that the phase difference value is 0, when the second integrated value is smaller than a predetermined threshold.

In one embodiment of this invention, step (c) may comprise: integrating an absolute value of the amplitude of the wobble signal over the predetermined interval to obtain a second integrated value; and performing division between the first integrated value and the second integrated value, and when a result of the division changes by more than a predetermined value from a result of a previous division, outputs a signal indicating that the phase difference value is 0.

In one embodiment of this invention, the wobble signal may be generated based on a wobbling shape of at least one track possessed by an information recording medium. A prepit may be previously provided at a position on the information recording medium, the position having a predetermined phase relationship with the wobble of the at least one track. The clock signal generation method may further comprise detecting a prepit signal from a reproduction signal obtained by irradiating the information recording medium with laser light. Step (c) may comprise: integrating an absolute value of the amplitude of the wobble signal over the predetermined interval to obtain a second integrated value, and integrating the amplitude of the wobble signal using the prepit signal as a reference to obtain a third integrated value; and performing subtraction between the first integrated value and the third integrated value, and performing division between a result of the subtraction and the second integrated value to obtain the phase difference value.

According to another aspect of the present invention, a method for generating a clock signal using an information recording medium is provided. The information recording medium comprises at least one track having a wobbling shape. The method comprises the steps of: generating a wobble signal based on the wobbling shape in accordance with a reproduction signal obtained by irradiating the information recording medium with laser light; and generating the clock signal synchronized with the wobble signal. The step of generating the clock signal comprises the steps of: (a) generating the clock signal; (b) generating a predetermined count value; (c) integrating an amplitude value of the wobble signal over a predetermined interval specified based on the predetermined count value to obtain a first integrated value, and obtaining a phase difference value indicating a phase difference between the wobble signal and the clock signal based on the first integrated value; and (d) generating a control signal based on the phase difference value, the control signal being used for controlling a frequency of the clock signal. The step of generating the clock signal comprises adjusting the frequency of the clock signal based on the control signal.

In one embodiment of this invention, step (c) may comprise: integrating an absolute value of the amplitude of the wobble signal over the predetermined interval to obtain a second integrated value; and performing division between the first integrated value and the second integrated value to obtain the phase difference value.

According to the present invention, an amplitude value of a wobble signal is integrated to obtain a first integrated value. Based on the first integrated value, a phase difference value is obtained. Based on the phase difference value, a control signal is generated. A frequency of the clock signal is adjusted based on the control signal. As a result, even when the quality of a wobble signal is deteriorated (e.g., distorted, etc.) due to noise or the like, highly precise phase comparison can be performed, thereby generating a stable clock signal.

According to one embodiment of the present invention, an absolute value of the amplitude of the wobble signal is integrated to obtain a second integrated value. Division is performed between the first integrated value and the second integrated value to obtain a phase difference value. By the division, a normalized phase difference value can be obtained with respect to the amplitude or cycle of the wobble signal. Therefore, the phase difference value can be obtained with a constant gain for a difference in phase angle between the wobble signal and the clock signal without being influenced by a variation in the amplitude of the wobble signal due to crosstalk or the like, resulting in a stable clock signal. In addition, even when a wobble cycle varies from format to format, a phase difference value can be obtained with a constant gain for a difference in phase angle. Therefore, a loop filter means having a simple structure can be employed.

According to another embodiment of the present invention, a dropout portion or a modulated portion indicating an address of a wobble signal is detected using the first integrated value and the second integrated value, thereby making it possible to generate a stable clock signal without being influenced by the dropout portion or the modulated portion.

According to another embodiment of the present invention, by using a third integrated value using a prepit signal as a reference, a clock signal synchronized with both a wobble signal and the prepit signal can be generated.

Thus, the invention described herein makes possible the advantages of providing an apparatus, an integrated circuit and a method, which are capable of stably generating a clock signal even if the quality of a wobble signal is deteriorated.

These and other advantages of the present invention will become apparent to those skilled in the art upon reading and understanding the following detailed description with reference to the accompanying figures.

### BRIEF DESCRIPTION OF THE DRAWINGS

FIG. 1 is a block diagram showing a recording/reproduction apparatus according to Embodiment 1 of the present invention.

FIG. 2 is a timing diagram showing an operation of a phase reverse detector in Embodiment 1 of the present invention.

FIGS. 3A to 3D are timing diagrams showing operations of a phase comparator in Embodiment 1 of the present invention.

FIG. 4 is a graph showing an output value of the phase comparator in Embodiment 1 of the present invention.

FIG. 5 is a timing diagram showing an operation of a dropout detector in Embodiment 1 of the present invention.

FIG. 6 is a block diagram showing a recording/reproduction apparatus according to Embodiment 2 of the present invention.

FIGS. 7A and 7B are timing diagrams showing wobble signal waveforms of MSK modulation and PSK modulation.

FIGS. 8A and 8B are timing diagrams showing operations of a modulation portion detector in Embodiment 2 of the present invention.

FIG. 9A is a block diagram showing a recording/reproduction apparatus according to Embodiment 3 of the present invention.

FIG. 9B is a diagram showing a prepit in Embodiment 3 of the present invention.

FIG. 10 is a timing diagram showing waveforms of an LPP signal and a wobble signal.

FIG. 11 is a timing diagram showing a phase comparator in Embodiment 3 of the present invention.

FIG. 12 is a block diagram showing a recording/reproduction apparatus according to Embodiment 4 of the present invention.

FIG. 13 is a block diagram showing a conventional recording apparatus.

FIG. 14 is a timing diagram showing an operation of the conventional phase comparator of FIG. 13.

### DESCRIPTION OF THE PREFERRED EMBODIMENTS

Hereinafter, the present invention will be described by way of illustrative embodiments with reference to the accompanying drawings in which like reference numerals refer to like parts throughout the several views. The above-described parts will not be explained again in detail.

(Embodiment 1)

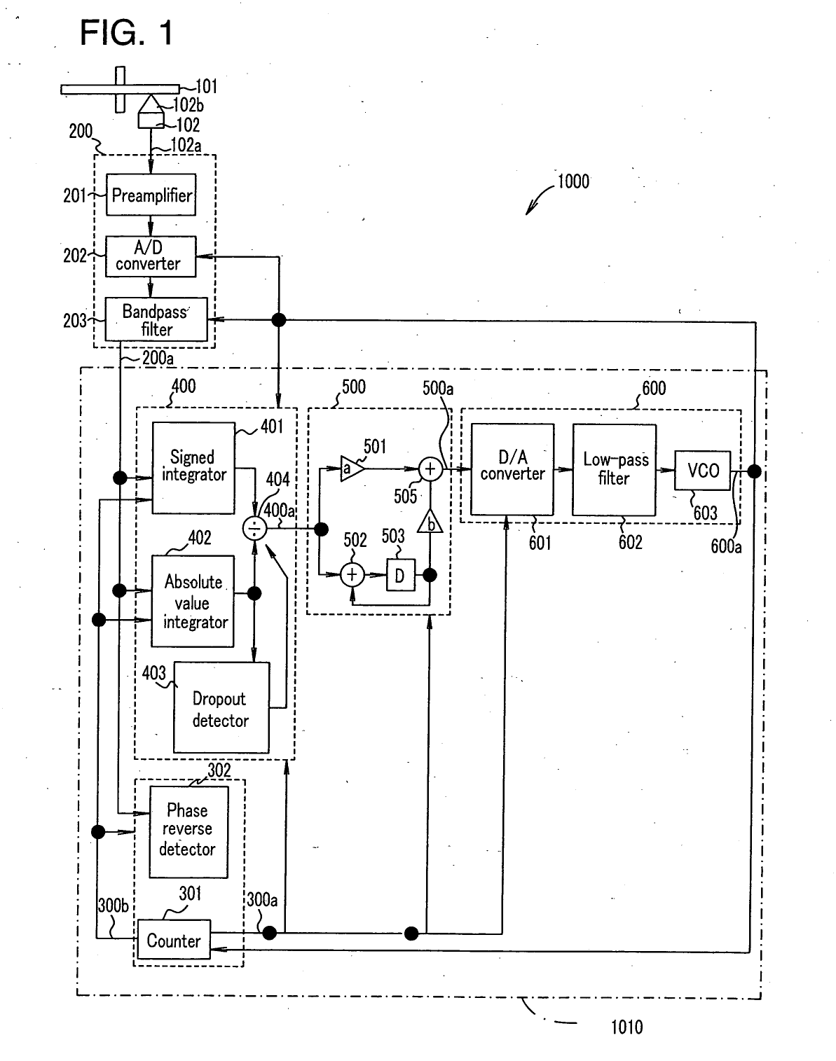

FIG. 1 is a block diagram showing a recording/reproduction apparatus 1000 according to Embodiment 1 of the present invention.

The recording/reproduction apparatus 1000 generates a clock signal using an information recording medium 101. The information recording medium 101 is a recordable medium which has at least one track in a wobbling shape, including, for example, an optical disc.

The recording/reproduction apparatus 1000 comprises an optical head section 102, a wobble detection circuit 200, and a clock signal generation apparatus 1010.

The optical head section 102 irradiates the information recording medium 101 with laser light 102b, detects an amount of reflected light from the information recording medium 101, and based on the amount of the reflected light, outputs a reproduction signal 102a.

The wobble detection circuit 200 functions as a wobble signal generation section, which generates a wobble signal based on the wobbling shape in accordance with the reproduction signal 102a obtained by irradiating the information recording medium 101 with the laser light 102b. The wobble detection circuit 200 comprises a preamplifier 201, an A/D converter 202, and a bandpass filter 203.

The clock signal generation apparatus 1010 functions as a PLL, which is operated so that a phase difference value indicating a phase difference between a wobble signal and a clock signal approaches zero, so that a-clock signal synchronized with the wobble signal is generated. The clock signal generation apparatus 1010 comprises a frequency division counter 300, a phase comparator 400, a loop filter 500, and a digital oscillator 600.

The frequency division counter 300 divides a clock signal by a predetermined division ratio of N (N is a natural number) to generate a predetermined count value (1 to N in Embodiment 1).

The phase comparator 400 calculates a first integrated value of an amplitude value of a wobble signal over a predetermined interval specified based on a predetermined count value. Based on the first integrated value, the phase comparator 400 calculates a phase difference value indicating a phase difference between the wobble signal and a clock signal. The phase comparator 400 outputs a phase difference value signal indicating the phase difference value.

The loop filter 500 functions as a control signal generation section which smoothes the phase difference value signal to generate a control signal for controlling a frequency of a clock signal. The digital oscillator 600 generates a clock signal 600a having a frequency based on the control signal output from the loop filter 500. The digital oscillator 600 adjusts the frequency of the clock signal 600a based on the control signal.

Next, an operation of the recording/reproduction apparatus 1000 will be described below in more detail.

The preamplifier 201 included in the wobble detection circuit 200 generates a tracking error signal based on the wobbling shape of a track from the reproduction signal 102a. The A/D converter 202 samples the tracking error signal in accordance with the clock signal 600a to convert the tracking error signal into a digital signal. The bandpass filter 203 is a digital filter which operates in accordance with the clock signal 600a, i.e., which extracts a wobble component from the digital signal generated by the A/D converter 202 to generate and output a wobble signal 200a.

The frequency division counter 300 comprises a counter 301 which divides the clock signal 600a into N, and a phase reverse detector 302 which detects the phase of the operation of the counter 301 and the phase of a wobble signal at intervals of 180 °.

The counter 301 divides the clock signal 600a into N to generate a frequency-divided clock signal 300a while counting from 1 to N. The counter 301 also generates a count value signal 300b indicating a count value. The phase reverse detector 302 samples the polarity of the wobble signal 200a at predetermined intervals. When the reverse polarity continued during a time that sampling is performed for a predetermined number of times or more, the timing for generation of a count value is shifted by half a cycle of the wobble signal 200a. In Embodiment 1, the phase reverse detector 302 samples a value of the wobble signal 200a when the count value of the counter 301 reaches N. The phase reverse detector 302 determines that the wobble signal 200a is shifted by 180°, when sampled values are negative consecutively a predetermined number of sampling times. In this case, the count value is corrected by N/2 (i.e., the timing of generating a count value is shifted by half a cycle of the wobble signal 200a).

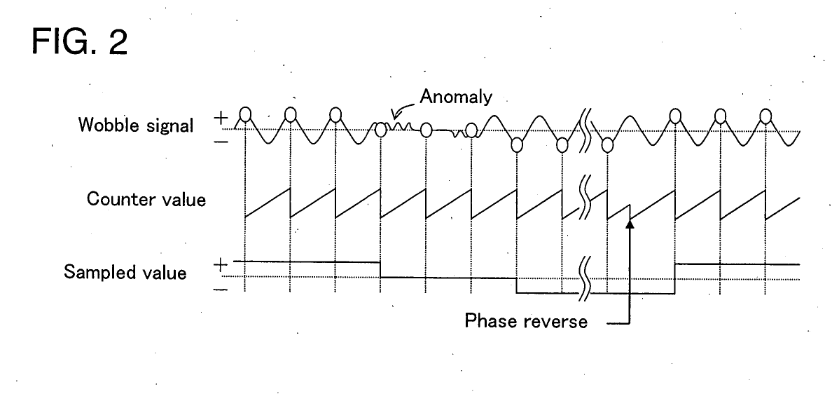

FIG. 2 is a timing diagram showing an operation of the phase reverse detector 302. FIG. 2 shows that an anomaly occurs in the wobble signal 200a since, for example, an irradiation position of the laser light 102b is moved from a desired track to another track, and thereafter, when a normal state is restored, the phase of the wobble signal 200a is shifted by 180°. Before the occurrence of the anomaly, when a count value is N, a sampled value of the wobble signal 200a is positive. However, after the occurrence of the anomaly, a sampled value is negative. When a sampled value is negative a predetermined consecutive number of sampling times, the phase reverse detector 302 determines that the phase of the wobble signal 200a is reversed, and the count value is corrected by N/2. Thereby, a normal synchronized state can be immediately restored, i.e., a time required for synchronizing the phase can be reduced.

The phase comparator 400 comprises a signed integrator 401, an absolute value integrator 402, a dropout detector 403, and a divider 404. The signed integrator 401 integrates a signed amplitude of the wobble signal 200a. The absolute value integrator 402 integrates an absolute value of the wobble signal 200a. The dropout detector 403 detects an anomaly, such as a dropout (momentary loss) or the like, of the wobble signal 200a. The divider 404 performs division between an integrated value calculated by the signed integrator 401 and an integrated value calculated by the absolute value integrator 402.

The signed integrator 401 integrates the amplitude of the wobble signal 200a where the polarity (positive or negative) of the wobble signal 200a is reversed in an interval from a count value of 1 to a count value of N/2 indicated by the count value signal 300b, while the polarity (positive or negative) of the wobble signal 200a is not reversed in an interval from N/2 to N, resulting in a signed integrated value (first integrated value). When the count value is 1, the signed integrator 401 resets the signed integrated value to zero and repeats integration similarly.

The absolute value integrator 402 integrates the absolute value of the wobble signal 200a over an interval from a count value of 1 to a count value of N indicated by the count value signal 300b, resulting in an absolute integrated value (second integrated value). When the count value is 1, the absolute value integrator 402 resets the absolute integrated value to zero and repeats integration similarly.

The dropout detector 403 compares the absolute integrated value with a predetermined threshold for detecting a dropout. When the absolute integrated value is smaller than the predetermined threshold for detecting a dropout, it is determined that the wobble signal 200a has a dropout portion. The divider 404 performs division between the signed integrated value and the absolute integrated value, and outputs the result of the division as a phase difference value. Although the signed integrated value is divided by the absolute integrated value to obtain a phase difference value in Embodiment 1, the absolute integrated value may be divided by the signed integrated value to obtain a phase difference value. When the dropout detector 403 determines that the wobble signal 200a has a dropout portion, the divider 404 outputs a phase difference value signal indicating that the phase difference value is zero.

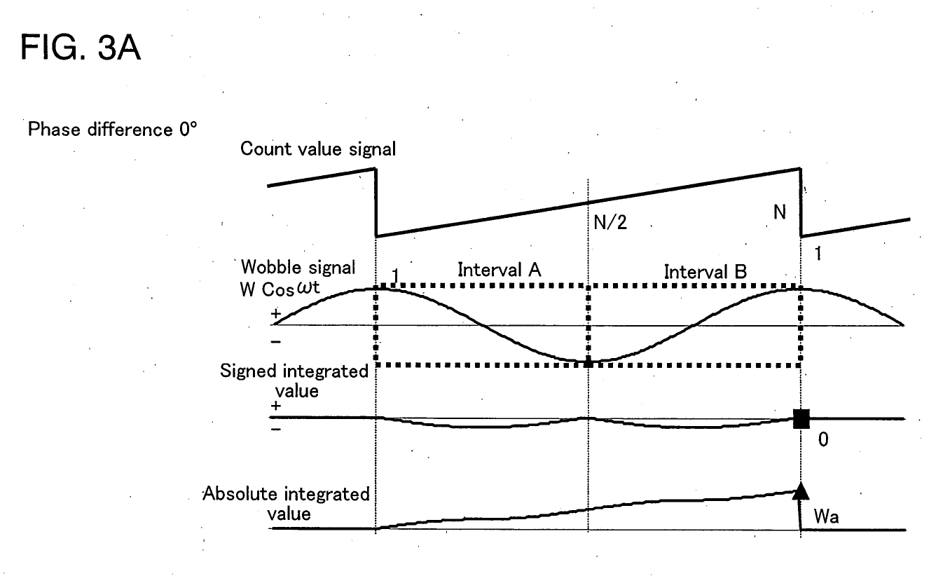

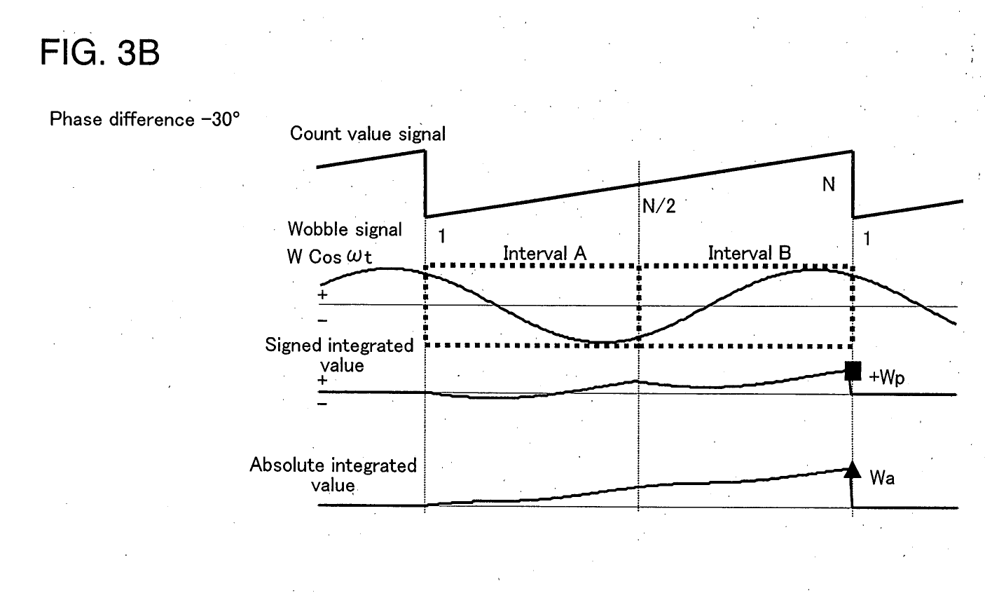

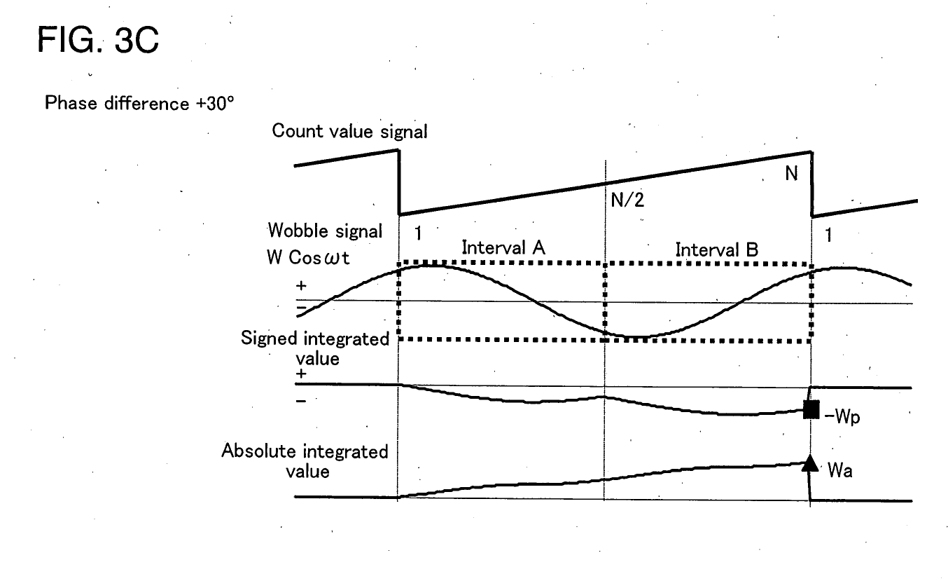

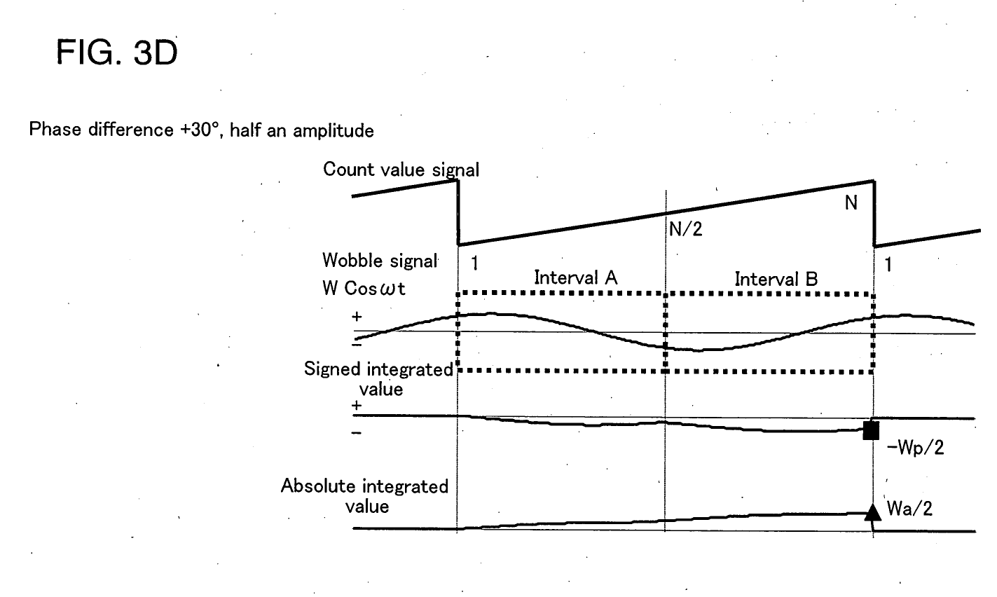

FIGS. 3A to 3D are timing diagrams showing operations of the phase comparator 400. FIG. 3A shows an operation of the phase comparator 400 when a phase difference between the wobble signal 200a and the count value signal 300b is 0°. FIG. 3B shows an operation of the phase comparator 400 when the phase of the count value signal 300b lags the phase of the wobble signal 200a by 30°. FIG. 3C shows an operation of the phase comparator 400 when the phase of the count value signal 300b leads the phase of the wobble signal 200a by 30°. FIG. 3D shows an operation of the phase comparator 400 when the phase of the count value signal 300b leads the phase of the wobble signal 200a by 30°, and the amplitude of the wobble signal 200a is halved.

In FIG. 3A, the signed integrator 401 integrates the wobble signal 200a where the polarity of the wobble signal 200a is reversed in an interval A ranging from a count value of 1 to a count value of N/2, while the polarity of the wobble signal 200a remains unchanged (i.e., not reversed) in an interval B ranging from N/2 to N. When the phase difference is 0°, the signed integrated value is 0. The absolute value integrator 402 integrates the absolute value of the wobble signal 200a in both the interval A and the interval B, resulting in an absolute integrated value of Wa. As a result, the divider 404 outputs a phase difference value of 0/Wa, i.e., 0.

As shown in FIG. 3B, when the phase of the count value signal 300b lags the phase of the wobble signal 200a, the signed integrated value is a positive value of +Wp. In this case, the absolute integrated value is constantly Wa irrespective of the phase difference. As a result, the output phase difference value is +Wp/Wa.

As shown in FIG. 3C, when the phase of the count value signal 300b leads the phase of the wobble signal 200a, the signed integrated value is a negative value of −Wp. In this case, the absolute integrated value is constantly Wa irrespective of the phase difference. As a result, the output phase difference value is −Wp/Wa.

FIG. 3D shows the core where the amplitude of the wobble signal 200a is half of that in FIG. 3C. Specifically, the signed integrated value is −Wp/2, while the absolute integrated value is Wa/2. In this case, the output phase difference value is −Wp/Wa which is the same as in FIG. 3C. Thus, by performing division, the output phase difference value is normalized with respect to the amplitude of the wobble signal 200a. Therefore, a phase difference value, which depends only on a difference in a phase angle, can be obtained irrespective of variations in the amplitude of the wobble signal 200a due to the influence of crosstalk or the like. Similarly, since the wobble cycle is also normalized, a phase difference value, which depends only on a difference in a phase angle, can be obtained no matter that the wobble cycle varies from format to format.

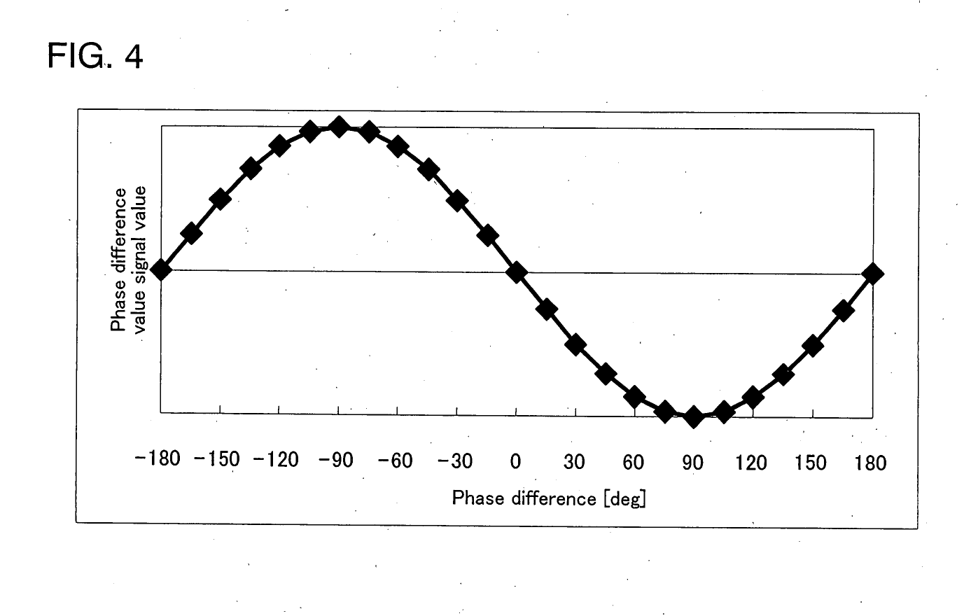

FIG. 4 is a graph showing a relationship between a difference in phase angle and the value of a phase difference value signal 400a output by the phase comparator 400. When the phase difference is 0°, the value of the phase difference value signal is 0. When the phase difference is a negative value, i.e., the phase of the count value signal 300b lags the phase of the wobble signal 200a, the value of the phase difference value signal is a positive value. When the phase difference is a positive value, i.e., the phase of the count value signal 300b leads the phase of the wobble signal 200a, the value of the phase difference value signal is a negative value. As described above, the value of the phase difference value signal depends only on the difference in phase angle irrespective of the amplitude of the wobble signal 200a and the cycle of the wobble signal 200a (the division ratio N of the frequency division counter). When the phase difference is in the range of 90° to 180° or −90° to −180°, a phase to be controlled is reverse. In this case, the phase reverse detector 302 is used to correct the phase relationship.

In addition, the phase difference value is integrated over a one-cycle interval of the wobble signal, whereby a correct value can be obtained while reducing the influence of a noise component. Therefore, even when the quality of the wobble signal 200a is deteriorated, the operation of the PLL does not become unstable and a precise clock signal 600a can be generated.

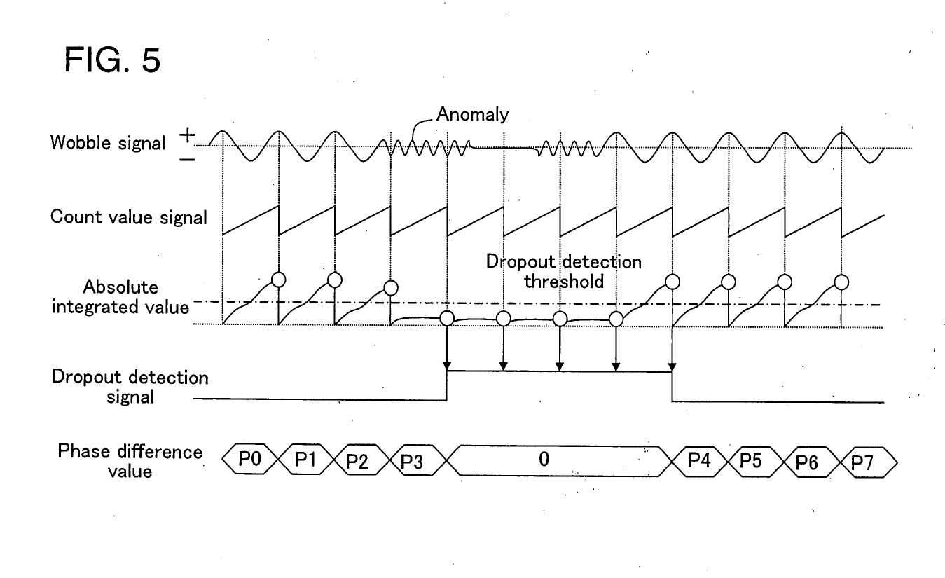

FIG. 5 is a timing diagram showing an operation of the dropout detector 403. When an anomaly occurs in the wobble signal 200a due to a scratch, a stain (e.g., a fingerprint, etc.), or the like, on a recording side of the information recording medium 101, the amplitude of the wobble signal 200a is reduced. As a result, the absolute integrated value is very small compared to when the wobble signal 200a is normal. By utilizing this, when the absolute integrated value is smaller than a predetermined threshold for detecting a dropout, the dropout detector 403 determines that the wobble signal 200a is not normal, and outputs a dropout detection signal. During the time when the dropout detection signal is being output, the divider 404 outputs a phase difference value signal indicating that the phase difference value is O, irrespective of the result of division. Therefore, it is possible to prevent an unstable operation of the PLL due to an abnormal wobble signal, so that a stable clock signal 600a can be continuously generated.

The loop filter 500 comprises an amplifier 501, an addition circuit 502, a delayer 503, another amplifier 504, and another addition circuit 505. The amplifier 501 multiplies a phase difference value by a. The delayer 503 delays an output value of the addition circuit 502 by one cycle of a wobble signal. A phase difference value is integrated using the addition circuit 502 and the delayer 503. The amplifier 504 multiplies the integrated value by b. The addition circuit 505 adds an output of the amplifier 501 with an output of the amplifier 504. The loop filter 500 performs calculation based a timing indicated by the frequency-divided clock signal 300a generated by the frequency division counter 300. The loop filter 500 outputs a control signal 500a indicating a value obtained by adding the output (a-fold proportion value) of the amplifier 501 with the output (b-fold integration value) of the amplifier 504. The control signal 500a is used to control the subsequent digital oscillator 600.

The digital oscillator 600 comprises a D/A converter 601, a low-pass filter 602, and a voltage control oscillator (VCO) 603. The digital oscillator 600 generates the clock signal 600a having a frequency based on the control signal 500a. The D/A converter 601 converts the control signal 500a into an analog signal. The low-pass filter 602 removes from the analog signal, an unnecessary, high frequency component generated when the value of the control signal 500a is changed. The VCO 603 generates the clock signal 600a having a frequency based on a voltage value indicated by an output signal of the low-pass filter 602. The clock signal 600a is supplied to the A/D converter 202, the bandpass filter 203, the phase comparator 400, and the counter 301.

As described above, according to Embodiment 1, a stable clock signal can be generated without being influenced by an amplitude change, noise, a dropout, or the like of a wobble signal. Further, by using a phase comparator whose output value is not influenced by the cycle of a wobble signal, a plurality of optical disc formats having different wobble signal cycles can be easily supported.

Although the phase comparator 400, the loop filter 500, and the digital oscillator 600 each have an operating cycle which is equal to one cycle of a wobble signal (frequency-divided clock) in Embodiment 1, such an operating cycle may be equal to ½ cycle of a wobble signal.

Although the operating cycles of the wobble detection circuit 200 and each integrator of the phase comparator 400 are equal to a clock signal cycle, the present invention is not limited to this. The operating cycle may be much faster than that of a wobble signal, including, for example, the frequency of the clock signal multiplied by two or a power of two. In this case, the same effect can be obtained.

Although the apparatus 1000 has been described as a recording/reproduction apparatus, it may be a recording apparatus or a reproduction apparatus.

(Embodiment 2)

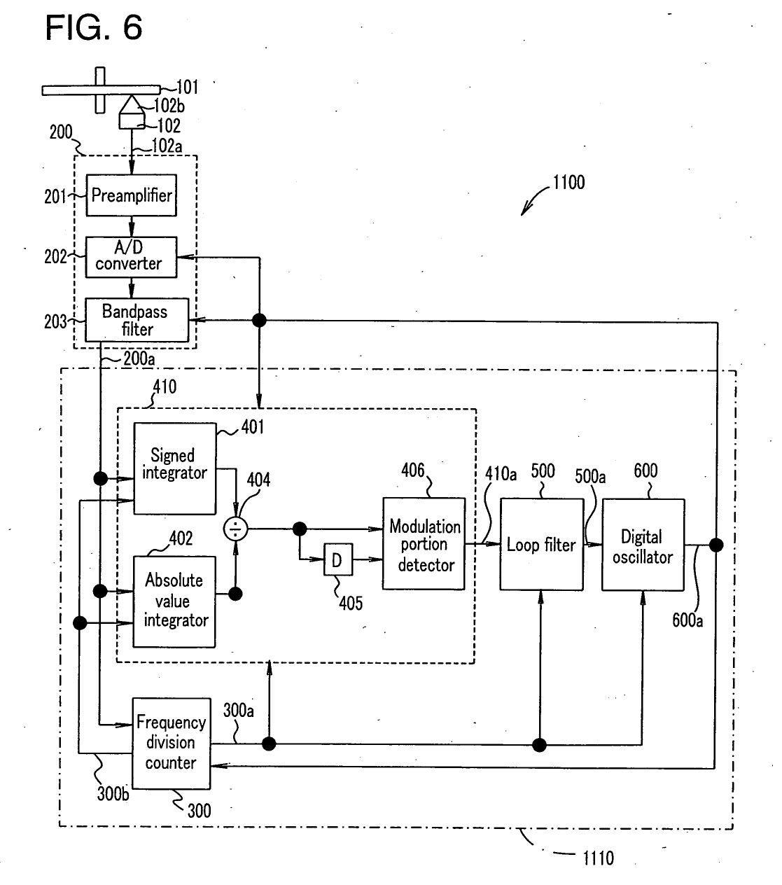

FIG. 6 is a block diagram showing a recording/reproduction apparatus 1100 according to Embodiment 2 of the present invention. The recording/reproduction apparatus 1100 comprises a clock signal generation apparatus 1110. In FIG. 6, the same parts as those shown in FIG. 1 are indicated by the same -reference numerals and will not be explained further.

In Embodiment 2, the frequency or phase of a wobble of a track on an information recording medium 101 is modulated to represent an address.

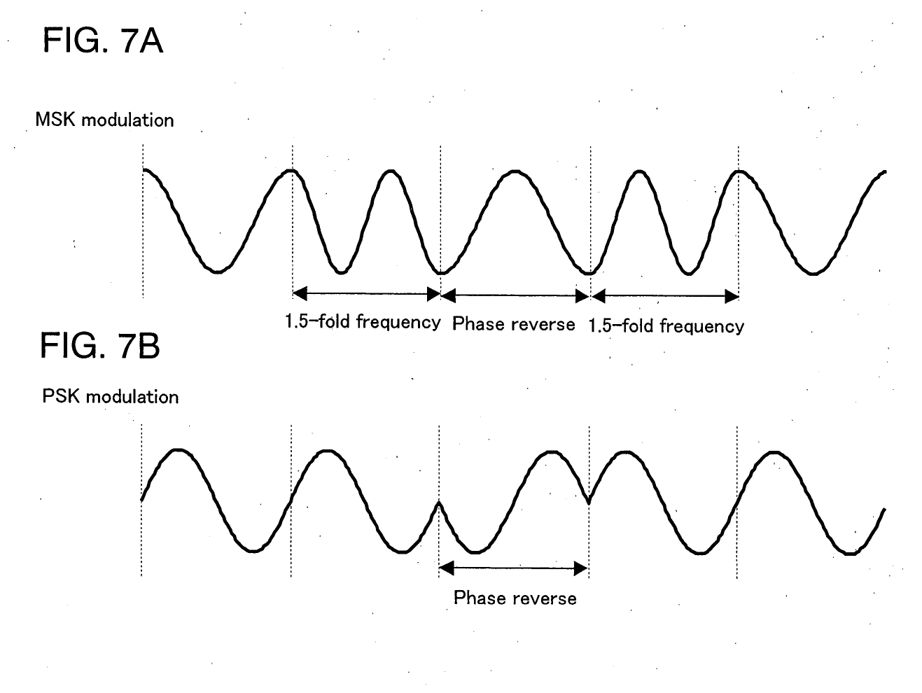

Modulation of the frequency and phase of the wobble of a track will be described with reference to FIGS. 7A and 7B. FIGS. 7A and 7B show a waveform of a modulated wobble signal. In order to record data at a predetermined position, a recording side of the information recording medium 101 is provided with addresses along a track groove. The addresses are recorded by, for example, modulating the frequency or phase of the wobble of the track. Figure 7A shows a waveform of a wobble signal obtained from a wobbling track shape modulated by minimum shift keying (MSK) modulation. FIG. 7B shows a waveform of a wobble signal obtained from a wobbling track shape modulated by phase shift keying (PSK) modulation.

MSK modulation is continuous phase frequency shift keying (FSK) modulation with a modulation index of 0.5. In FSK modulation, two sine signals having a frequency of f1 and a frequency of f2 are used to represent codes (e.g., “0” and “1”) of data to be modulated. Specifically, a sine waveform having a frequency of f1 is used to represent “0”, while a sine waveform having a frequency of f2 is used to represent “1”. In continuous phase FSK modulation, the phases of two sine signals are continuous at a position where a code of data to be modulated is changed. In this FSK modulation, a modulation index m is represented by:
m=|f1−f2|T
where T is a transmission rate (1/minimum code length time) of data to be modulated. When m is 0.5, the continuous phase FSK modulation is called MSK modulation. MSK modulation uses two sine signals where one signal has a frequency 1.5 times that of the other signal. Specifically, in MSK modulation, one signal waveform is cos(ωt) or −cos(ωt), while the other waveform is cos(1.5ωt) or −cos(1.5ωt). As shown in FIG. 7A, a wobble signal has a waveform for each cycle, i.e., cos(ωt), cos(ωt), Cos(1.5ωt), −cos(ωt), −cos(1.5ωt), cos(ωt), and cos(ωt), depending on a code pattern.

In PSK modulation, the phase of wobble is modulated where the frequency is constant, and phases p1 and p2 are used to represent codes (e.g., “0” and “1”) of data to be modulated. FIG. 7B shows PSK modulation where the phase p1 is 0° and the phase p2 is 180°. A wobble signal has a waveform, sin(ωt) or −sin(ωt), for each cycle, depending on a code pattern of data to be modulated.

The clock signal generation apparatus 1110 of FIG. 6 comprises a frequency division counter 300, a phase comparator 410, a loop filter 500, and a digital oscillator 600.

The phase comparator 410 comprises a delayer 405 and a modulation portion detector 406. The delayer 405 delays an output signal of a divider 404 by one wobble cycle. The modulation portion detector 406 compares an output signal value of the divider 404 with an output signal value of the delayer 405 (i.e., an output signal value of the divider 404 of the previous wobble cycle) to detect a portion of a wobble signal which is modulated.

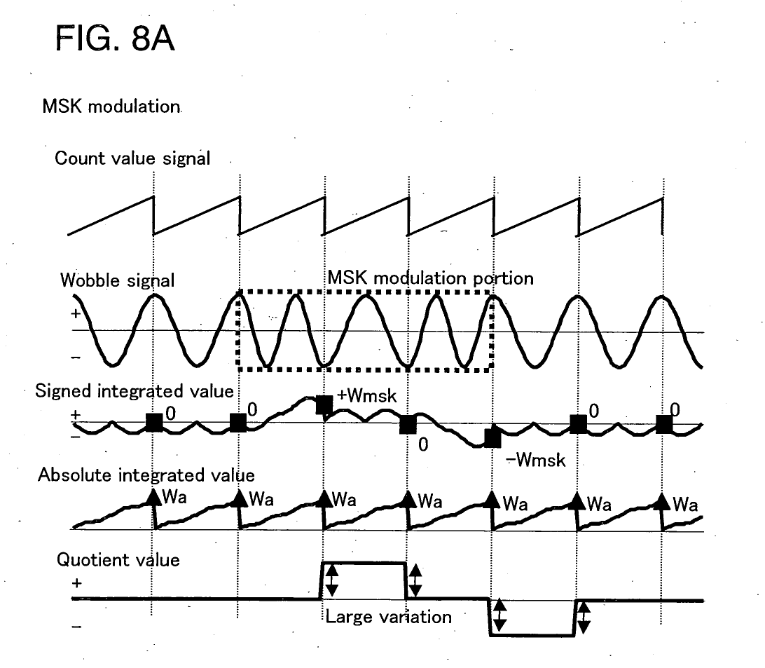

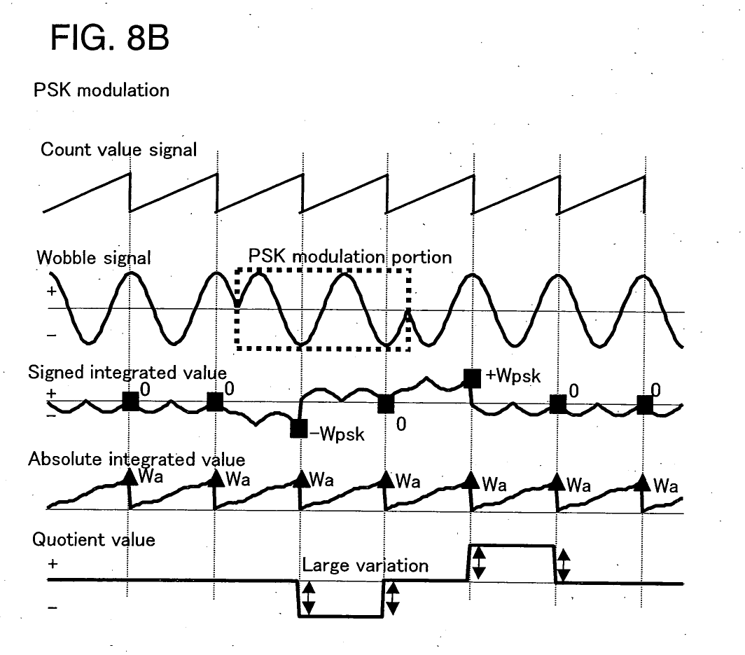

FIGS. 8A and 8B are timing diagrams showing an operation of the phase comparator 410 before and after a modulated portion. FIG. 8A shows an operation in MSK modulation, while FIG. 8B shows an operation in PSK modulation.

Referring to FIG. 8A, the signed integrated value is +Wmsk in the first one-cycle interval of a portion of a wobble signal which is subjected to MSK modulation. In the next one-cycle interval, the phase is reversed by 180°, so that the signed integrated value is 0. In the last one-cycle interval, the signed integrated value is −Wmsk. The absolute integrated value is substantially constantly Wa, though it varies slightly, depending on the phase difference. Therefore, a quotient value undergoes a large change in the positive direction at the leading portion of the MSK modulation portion and in the negative-direction at the tailing portion of the MSK modulation portion, as compared to portions other than the MSK modulation portion.

In FIG. 8B, the signed integrated value is −Wpsk in the first one-cycle interval of a portion of a wobble signal which is subjected to PSK modulation. In the next one-cycle interval, the phase is reversed by 180°, so that the signed integrated value is 0. In the last one-cycle interval, the signed integrated value is +Wpsk. The absolute integrated value is substantially constantly Wa irrespective of PSK modulation. Therefore, the quotient value undergoes a large change in the negative direction at the leading portion of the PSK modulation portion and in the positive direction at the tailing portion of the PSK modulation portion, as compared to portions other than the PSK modulation portion.

As described above, the quotient value undergoes a large change in a portion of a wobble signal which has been subjected to MSK modulation or PSK modulation. If such a modulated portion is directly reproduced, the operation of the PLL becomes unstable. Therefore, based on the fact that the quotient value undergoes a large change in an MSK modulation portion or a PSK modulation portion as compared to the other portions, the modulation portion detector 406 outputs a phase difference value signal indicating that the phase difference value is 0 when a quotient value of interest changes by more than a predetermined value from a previous quotient value. In Embodiment 2, when a quotient value of interest changes by more than a predetermined value from the immediately previous quotient value (i.e., an output signal value of the delayer 405), the modulation portion detector 406 determines that the changed portion is a modulated portion, and outputs a phase difference value signal 410a indicating 0 irrespective of the result of the division.

As described above, according to Embodiment 2, a modulated portion of a wobble signal is detected during the step of phase comparison. Thereafter, by masking a phase difference value in the modulated portion, the clock signal 600a can be generated stably without being influenced by modulation.

In Embodiment 2, wobble is modulated by MSK modulation or PSK modulation. The present invention is not limited to this.

The modulation portion detector 406 specifies a modulated portion based on a variation amount obtained by comparing a quotient value of interest with the immediately previous quotient value. The present invention is not limited to this. Alternatively, a modulation portion can be specified based on the result of comparison of a quotient value of interest with a plurality of previous quotient values, resulting in the same effect.

(Embodiment 3)

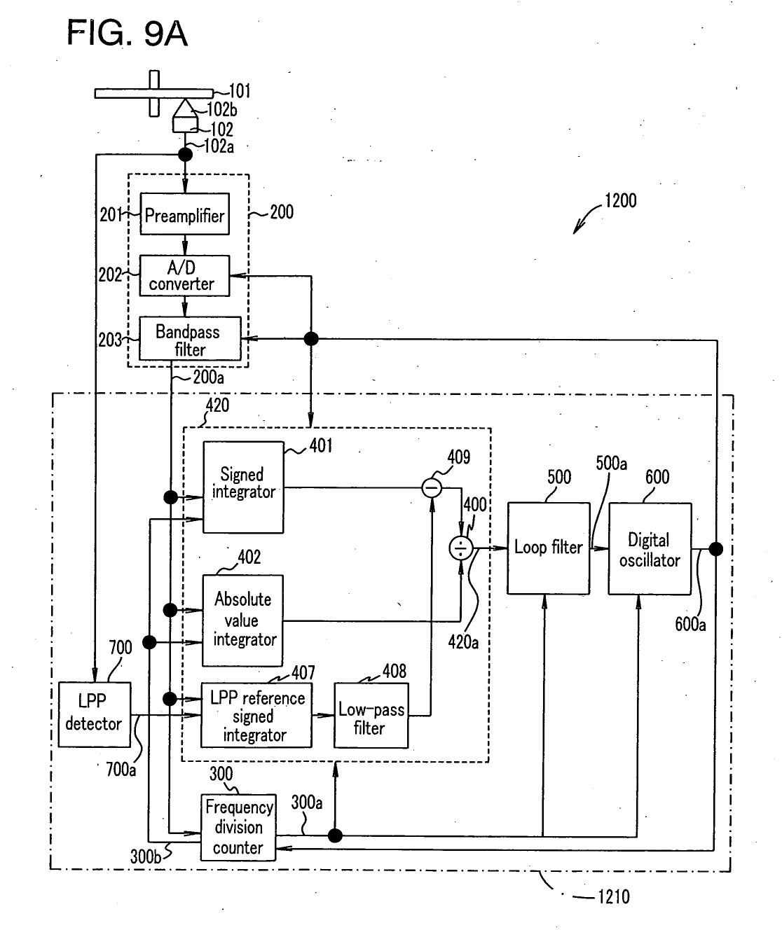

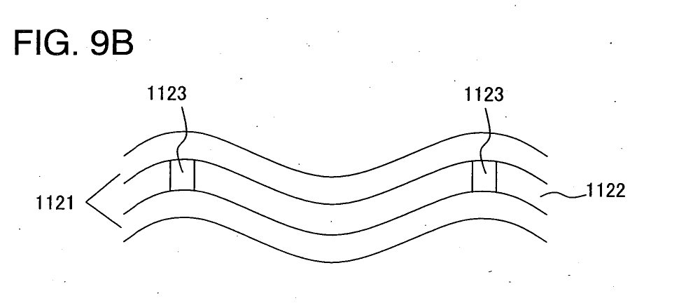

FIG. 9A is a block diagram showing a recording/reproduction apparatus 1200 according to Embodiment 3 of the present invention. The recording/reproduction apparatus 1200 comprises a clock signal generation apparatus 1210. In FIG. 9A, the same parts as those shown in FIG. 1 are indicated by the same reference numerals and will not be explained further.

In Embodiment 3, as shown in FIG. 9B, an information recording medium 101 has track grooves 1121 and land prepits (LPP) 1123. The land prepits 1123 are previously formed between adjacent track grooves 1121 (i.e., a land 1122). The land prepit 1123 has a predetermined phase relationship with the wobble of the track groove 1121. The land prepit 1123 indicates an address.

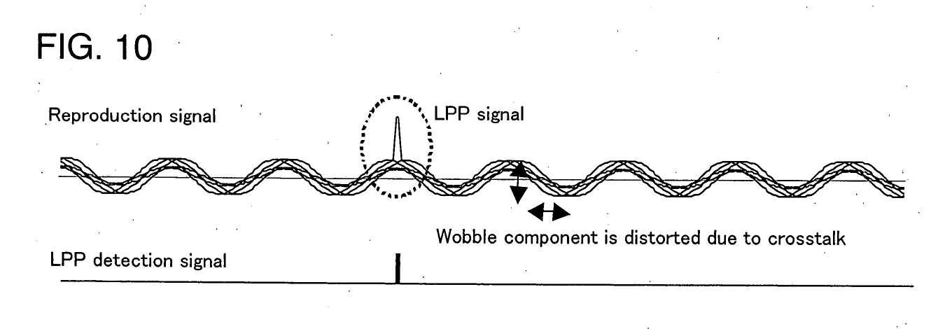

A land prepit (LPP) will be described below. FIG. 10 shows a reproduction signal 102a including an LPP signal indicating an LPP. The LPP signal is included in a wobble component contained in the reproduction signal 102a. By comparing the reproduction signal 102a with a predetermined threshold signal, an LPP detection signal 700a can be obtained. In a reproduction signal, an LPP signal can be obtained at a predetermined position, however, the amplitude, phase, or duty of a wobble component of a track of interest deviates from the correct value due to the influence of an adjacent track, such as crosstalk or the like. In order to reproduce recording data stably, the clock signal generation apparatus 1210 needs to generate a clock signal which is in synchronization with a wobble component of a track of interest without being influenced by a change in the wobble component.

The clock signal generation apparatus 1210 comprises a frequency division counter 300, a phase comparator 420, a loop filter 500, a digital oscillator 600, and an LPP detector 700.

The LPP detector 700 detects an LPP signal from a reproduction signal 102a which has been obtained by irradiating the information recording medium 101 with laser light 102b, and outputs an LPP detection signal 700a. The phase comparator 420 comprises an LPP reference signed integrator 407, a low-pass filter 408, and a subtraction circuit 409.

The LPP reference signed integrator 407 integrates an amplitude of a wobble signal over a wobble signal one-cycle interval of the wobble signal with reference to a timing indicated by the LPP detection signal 700a to obtain an integrated value (LPP reference signed integrated value: third integrated value). The low-pass filter 408 smoothes a signal indicating the LPP reference signed integrated value. The subtraction circuit 409 performs subtraction between a signed integrated value calculated by the signed integrator 401 and the LPP reference signed integrated value. In Embodiment 3, the LPP reference signed integrated value is subtracted from the signed integrated value output by the signed integrator 401. Alternatively, the signed integrated value output by the signed integrator 401 may be subtracted from the LPP reference signed integrated value. The divider 404 performs division between the result of the subtraction performed by the subtraction circuit 409 and an absolute integrated value calculated by an absolute value integrator 402 to obtain a phase difference value. In Embodiment 3, the result of the subtraction is divided by the absolute integrated value. Alternatively, the absolute integrated value may be divided by the result of the subtraction. The divider 404 outputs a phase difference value signal 420a indicating a phase difference value.

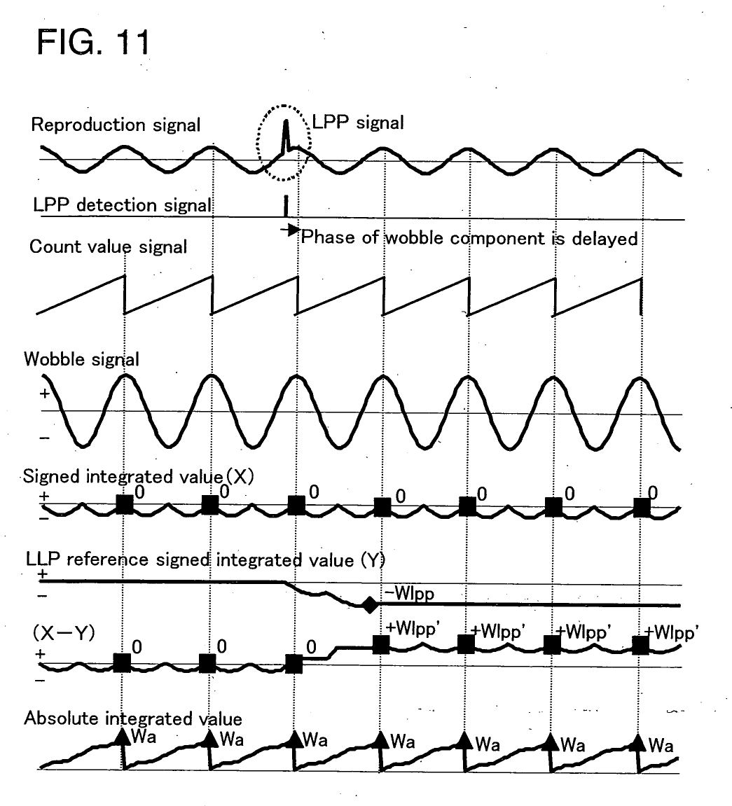

An operation of the phase comparator 420 will be described in more detail with reference to FIG. 11.

In FIG. 11, a wobble component contained in a reproduction signal lags the phase of the wobble of a track of interest due to the influence of crosstalk. From the reproduction signal, the LPP detector 700 obtains an LPP detection signal 700a and the wobble detection circuit 200 obtains a wobble signal 200a.

The phase difference between a count value signal and the wobble signal is 0°, and therefore, the signed integrated value is 0. The LPP reference signed integrator 407 obtains an integrated value of the wobble signal over its one-cycle interval using an output position of the LPP detection signal as a reference. In FIG. 11, a positive peak position of the wobble signal lags an LPP signal, so that an LPP reference signed integrated value is a negative value of −Wlpp. Conversely, when the positive peak position of the wobble signal leads the LPP signal, the LPP reference signed integrated value is +Wlpp. A signal indicating the LPP reference signed integrated value is smoothed by the low-pass filter 408, and the resultant value is output as −Wlpp′. In the subtraction circuit 409, the output value of the low-pass filter 408 is subtracted from the signed integrated value, resulting in +Wlpp′. Therefore, the divider 404 obtains a phase difference value of +Wlpp′/Wa.

The clock signal generation apparatus 1210 generates the clock signal 600a while operating as a PLL in a manner that causes a phase difference value obtained by the phase comparator 420 to be 0.

As described above, according to Embodiment 3 a clock signal 600a can be obtained which is in synchronization with a wobble signal and an LPP signal, i.e., the influence of crosstalk is removed.

Although the low-pass filter 408 is used as a means for smoothing the LPP reference signed integrated value, the present invention is not limited to this. A mean value of the LPP reference signed integrated value may be used.

(Embodiment 4)

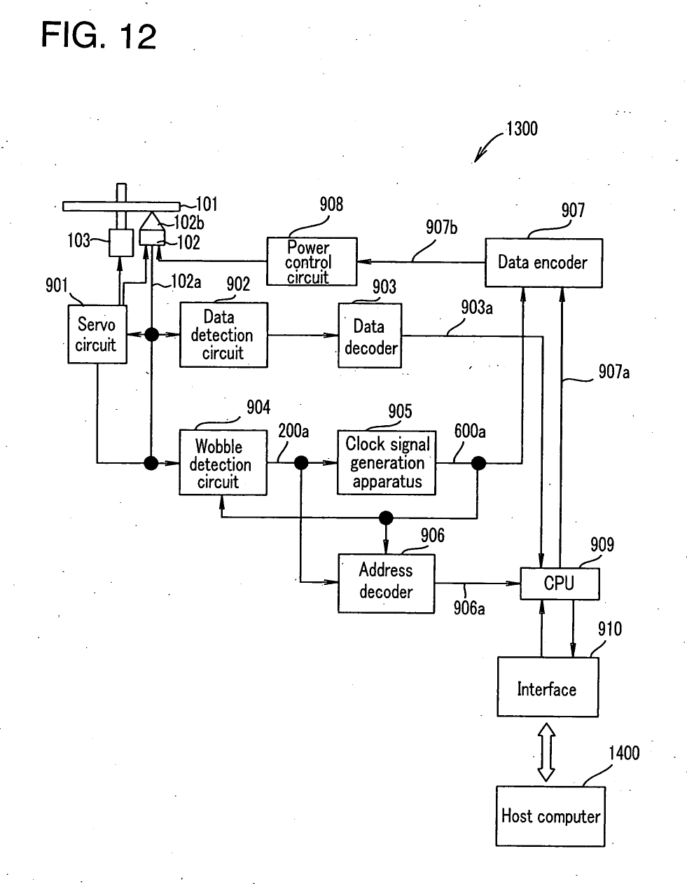

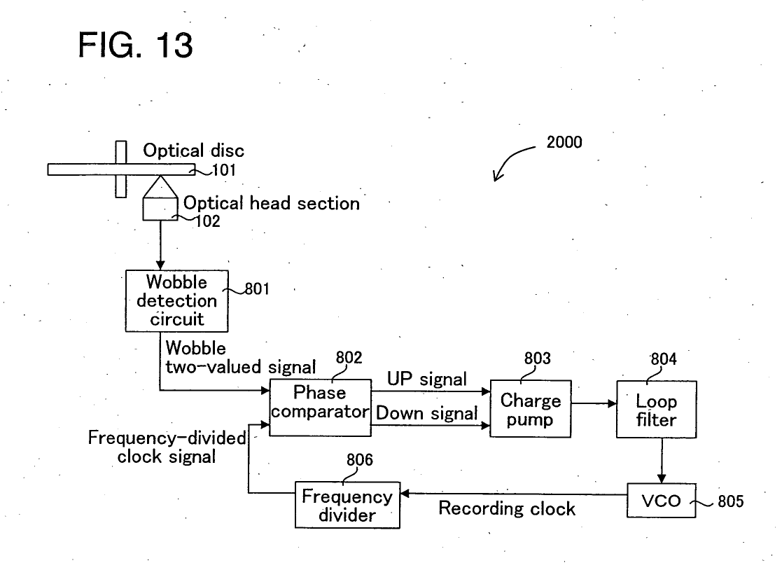

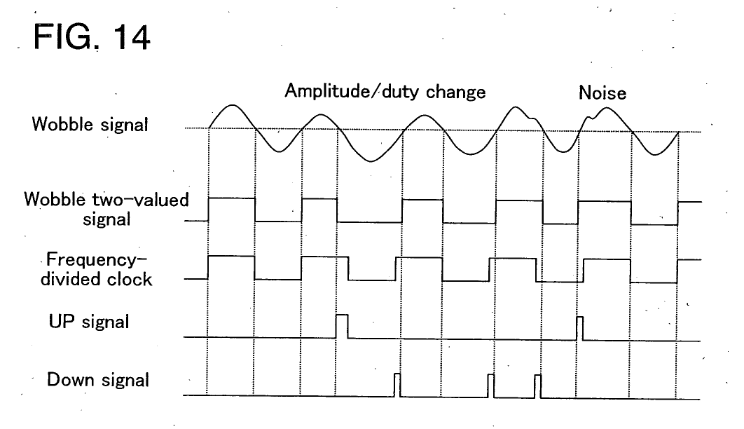

FIG. 12 is a block diagram showing a recording/reproduction apparatus 1300 according to Embodiment 4 of the present invention. In FIG. 12, the same parts as those shown in FIG. 1 are indicated by the same reference numerals and will not be explained further.

The recording/reproduction apparatus 1300 comprises an optical head section 102, a motor 103, a servo circuit 901, a data detection circuit 902, a data decoder 903, a wobble detection circuit 904, a clock signal generation apparatus 905, an address decoder 906, a data encoder 907, a power control circuit 908, a CPU 909, and an interface 910.

The optical head section 102 irradiates an information recording medium 101 with laser light. The motor 103 rotates the information recording medium 101. The servo circuit 901 controls the motor 103 and the optical head section 102. The data detection circuit 902 extracts a data signal from a reproduction signal 102a obtained by the optical head section 102. The data decoder 903 demodulates a data signal to obtain reproduced data 903a. The wobble detection circuit 904 extracts a wobble signal 200a from a reproduction signal 102a. The clock signal generation apparatus 905 is any one of the clock signal generation circuits 1010, 1110, and 1210 of Embodiments 1 to 3. The address decoder 906 generates address information 906a from a wobble signal. The data encoder 907 modulates recording data 907a. The power control circuit 908 controls a laser power of the optical head section 102. The CPU 909 controls the operation of the whole recording/reproduction apparatus 1300. The recording/reproduction apparatus 1300 receives and outputs recording information and reproduced information from and to an external host computer 1400 via the interface 910.

An operation of the recording/reproduction apparatus 1300 will be described in more detail.

Laser light emitted by the optical head section 102 is focused onto a track on the information recording medium 101. The optical head section 102 scans the track while detecting an amount of reflected light from the information recording medium 101, to obtain the reproduction signal 102a. The servo circuit 901 uses the reproduction signal 102a to control the rpm of the motor 103, a focus state of laser of the optical head section 102, and a scan state of a track.

In addition, from the reproduction signal 102a, the data detection circuit 902 extracts a data signal based on data recorded on the information recording medium 101. Thereafter, the data decoder 903 demodulates the data signal to obtain the reproduced data 903a recorded on the information recording medium 101.

In addition, from the reproduction signal 102a, the wobble detection circuit 904 extracts the wobble signal 200a based on the wobbling shape of a track on the information recording medium 101. The clock signal generation apparatus 905 generates the clock signal 600a based on the extracted wobble signal 200a. The address decoder 906 uses the clock signal 600a to detect the address information 906a of the information recording medium 101 contained in the wobble signal 200a.

The data encoder 907 modulates the recording data 907a to be recorded, and outputs the modulated signal 907b to the power control circuit 908 in accordance with the clock signal 600a. The power control circuit 908 controls the power of the laser light 102b in accordance with the input modulated signal 907b. The optical head section 102 records the information onto the information recording medium 101.

The CPU 909 obtains the address information 906a and controls recording and reproduction, and also receives and outputs from and to a host computer via the information interface 910.

As described above, according to Embodiment 4, by using a clock signal generated by the clock signal generation apparatus of Embodiments 1 to 3, it is possible to stably reproduce address information and record user data even when the quality of a wobble signal is reduced due to deterioration in the quality of the information recording medium 101, the performance of the optical head section 102, or the like.

Although a signed integrated value is divided by an absolute integrated value to obtain a phase difference value in the above-described embodiments, the absolute integrated value may be divided by the signed integrated value to obtain a phase difference value.

Although the apparatuses 1000, 1100, 1200, and 1300 are described as recording/reproduction apparatuses in the above-described embodiments, they may be recording apparatuses or reproduction apparatuses.

The clock signal generation apparatus of the present invention may be implemented as an integrated circuit, such as an LSI. The components of the clock signal generation apparatus may be fabricated on separate chips. Alternatively, a part or the whole of the clock signal generation apparatus may be fabricated on a single chip.

Examples of an integrated circuit include ICs, system LSIs, super LSIs, and ultra LSIs, which are classified according to the scale of integration.

An integrated circuit as used herein is not limited to an LSI and may be a specialized circuit or a general-purpose processor. An integrated circuit as used herein may also be a field programmable gate array (FPGA) or a reconfigurable processor in which the connections and settings of circuit cells inside the LSI can be reconfigured.

The functional blocks of the present invention may be fabricated into an integrated circuit using a new or derivative technique instead of the LSI technology if such a technique would be developed by a progress in the semiconductor technology. Biotechnology may be applied to the present invention.

According to the present invention, a stable clock signal can be generated even when the quality of a wobble signal is deteriorated. In addition, even when a plurality of information recording media having different formats (e.g., the cycle of a wobble signal varies from format to format), a complex structure is not required for the clock signal generation apparatus.

Thus, the present invention is useful particularly in the technical field of information recording/reproduction and address information reproduction using a clock signal.

Although certain preferred embodiments have been described herein, it is not intended that such embodiments be construed as limitations on the scope of the invention except as set forth in the appended claims. Various other modifications and equivalents will be apparent to and can be readily made by those skilled in the art, after reading the description herein, without departing from the scope and spirit of this invention. All patents, published patent applications and publications cited herein are incorporated by reference as if set forth fully herein.

1. A clock signal generation apparatus for generating a clock signal synchronized with a wobble signal, comprising:
an oscillation section for generating the clock signal;
a counter section for generating a predetermined count value;
a phase comparison section for integrating an amplitude value of the wobble signal over a predetermined interval specified based on the predetermined count value to obtain a first integrated value, and obtaining a phase difference value indicating a phase difference between the wobble signal and the clock signal based on the first integrated value; and
a control signal generation section for generating a control signal based on the phase difference value, the control signal being used for controlling a frequency of the clock signal,
wherein the oscillation section adjusts the frequency of the clock signal based on the control signal.

2. A clock signal generation apparatus according to claim 1, wherein:
the phase comparison section integrates an absolute value of the amplitude of the wobble signal over the predetermined interval to obtain a second integrated value; and
the phase comparison section performs division between the first integrated value and the second integrated value to obtain the phase difference value.

3. A clock signal generation apparatus according to claim 1, wherein the wobble signal is generated based on a wobbling shape possessed by at least one track contained in an information recording medium.

4. A clock signal generation apparatus according to claim 1, wherein the counter section samples a polarity of the wobble signal every predetermined cycle, and when a reverse state of the polarity continues a predetermined number of sampling times or more, shifts a timing of generating the predetermined count value by half a cycle of the wobble signal.

5. A clock signal generation apparatus according to claim 1, wherein:
the phase comparison section integrates an absolute value of the amplitude of the wobble signal over the predetermined interval to obtain a second integrated value; and
the phase comparison section outputs a signal indicating that the phase difference value is 0, when the second integrated value is smaller than a predetermined threshold.

6. A clock signal generation apparatus according to claim 1, wherein:
the phase comparison section integrates an absolute value of the amplitude of the wobble signal over the predetermined interval to obtain a second integrated value; and
the phase comparison section performs division between the first integrated value and the second integrated value, and when a result of the division changes by more than a predetermined value from a result of a previous division, outputs a signal indicating that the phase difference value is 0.

7. A clock signal generation apparatus according to claim 1, wherein:
the wobble signal is generated based on a wobbling shape of at least one track possessed by an information recording medium;
a prepit is previously provided at a position on the information recording medium, the position having a predetermined phase relationship with wobble of the at least one track;
the clock signal generation apparatus further comprises a prepit signal detection section for detecting a prepit signal from a reproduction signal obtained by irradiating the information recording medium with laser light;
the phase comparison section integrates an absolute value of the amplitude of the wobble signal over the predetermined interval to obtain a second integrated value, and integrates the amplitude of the wobble signal using the prepit signal as a reference to obtain a third integrated value; and
the phase comparison section performs subtraction between the first integrated value and the third integrated value, and performs division between a result of the subtraction and the second integrated value to obtain the phase difference value.

8. An apparatus for generating a clock signal using an information recording medium, wherein the information recording medium comprises at least one track having a wobbling shape, the apparatus comprising:
a wobble signal generation section for generating a wobble signal based on the wobbling shape in accordance with a reproduction signal obtained by irradiating the information recording medium with laser light; and
a clock signal generation section for generating the clock signal synchronized with the wobble signal,
wherein the clock signal generation section comprises:
an oscillation section for generating the clock signal;
a counter section for generating a predetermined count value;
a phase comparison section for integrating an amplitude value of the wobble signal over a predetermined interval specified based on the predetermined count value to obtain a first integrated value, and obtaining a phase difference value indicating a phase difference between the wobble signal and the clock signal based on the first integrated value; and
a control signal generation section for generating a control signal based on the phase difference value, the control signal being used for controlling a frequency of the clock signal,
wherein the oscillation section adjusts the frequency of the clock signal based on the control signal.

9. An apparatus according to claim 8, wherein:
the phase comparison section integrates an absolute value of the amplitude of the wobble signal over the predetermined interval to obtain a second integrated value; and
the phase comparison section performs division between the first integrated value and the second integrated value to obtain the phase difference value.

10. An integrated circuit for generating a clock signal synchronized with a wobble signal, comprising:
an oscillation section for generating the clock signal;
a counter section for generating a predetermined count value;
a phase comparison section for integrating an amplitude value of the wobble signal over a predetermined interval specified based on the predetermined count value to obtain a first integrated value, and obtaining a phase difference value indicating a phase difference between the wobble signal and the clock signal based on the first integrated value; and
a control signal generation section for generating a control signal based on the phase difference value, the control signal being used for controlling a frequency of the clock signal,
wherein the oscillation section adjusts the frequency of the clock signal based on the control signal.

11. An integrated circuit according to claim 10, wherein:
the phase comparison section integrates an absolute value of the amplitude of the wobble signal over the predetermined interval to obtain a second integrated value; and
the phase comparison section performs division between the first integrated value and the second integrated value to obtain the phase difference value.

12. A clock signal generation method for generating a clock signal synchronized with a wobble signal, comprising the steps of:
(a) generating the clock signal;
(b) generating a predetermined count value;
(c) integrating an amplitude value of the wobble signal over a predetermined interval specified based on the predetermined count value to obtain a first integrated value, and obtaining a phase difference value indicating a phase difference between the wobble signal and the clock signal based on the first integrated value; and
(d) generating a control signal based on the phase difference value, the control signal being used for controlling a frequency of the clock signal,
wherein step (a) comprises adjusting the frequency of the clock signal based on the control signal.

13. A clock signal generation method according to claim 12, wherein step (c) comprises:
integrating an absolute value of the amplitude of the wobble signal over the predetermined interval to obtain a second integrated value; and
performing division between the first integrated value and the second integrated value to obtain the phase difference value.

14. A clock signal generation method according to claim 12, wherein the wobble signal is generated based on a wobbling shape of at least one track possessed by an information recording medium.

15. A clock signal generation method according to claim 12, wherein step (b) comprises sampling a polarity of the wobble signal every predetermined cycle, and when a reverse state of the polarity continues a predetermined number of sampling times or more, shifting a timing of generating the predetermined count value by half a cycle of the wobble signal.

16. A clock signal generation method according to claim 12, wherein step (c) comprises:
integrating an absolute value of the amplitude of the wobble signal over the predetermined interval to obtain a second integrated value; and
outputting a signal indicating that the phase difference value is 0, when the second integrated value is smaller than a predetermined threshold.

17. A clock signal generation method according to claim 12, wherein step (c) comprises:
integrating an absolute value of the amplitude of the wobble signal over the predetermined interval to obtain a second integrated value; and
performing division between the first integrated value and the second integrated value, and when a result of the division changes by more than a predetermined value from a result of a previous division, outputing a signal indicating that the phase difference value is 0.

18. A clock signal generation method according to claim 12, wherein:
the wobble signal is generated based on a wobbling shape of at least one track possessed by an information recording medium;
a prepit is previously provided at a position on the information recording medium, the position having a predetermined phase relationship with wobble of the at least one track;
the clock signal generation method further comprises detecting a prepit signal from a reproduction signal obtained by irradiating the information recording medium with laser light;
step (c) comprises:
integrating an absolute value of the amplitude of the wobble signal over the predetermined interval to obtain a second integrated value, and integrating the amplitude of the wobble signal using the prepit signal as a reference to obtain a third integrated value; and
performing subtraction between the first integrated value and the third integrated value, and performing division between a result of the subtraction and the second integrated value to obtain the phase difference value.

19. A method for generating a clock signal using an information recording medium, wherein the information recording medium comprises at least one track having a wobbling shape, the method comprising the steps of:
generating a wobble signal based on the wobbling shape in accordance with a reproduction signal obtained by irradiating the information recording medium with laser light; and
generating the clock signal synchronized with the wobble signal,
wherein the step of generating the clock signal comprises the steps of:
(a) generating the clock signal;
(b) generating a predetermined count value;
(c) integrating an amplitude value of the wobble signal over a predetermined interval specified based on the predetermined count value to obtain a first integrated value, and obtaining a phase difference value indicating a phase difference between the wobble signal and the clock signal based on the first integrated value; and
(d) generating a control signal based on the phase difference value, the control signal being used for controlling a frequency of the clock signal,
wherein the step of generating the clock signal comprises adjusting the frequency of the clock signal based on the control signal.

20. A method according to claim 19, wherein step (c) comprises:
integrating an absolute value of the amplitude of the wobble signal over the predetermined interval to obtain a second integrated value; and
performing division between the first integrated value and the second integrated value to obtain the phase difference value.
